(19) United States
(12) Patent Application Publication
(10) Pub. No.: US 2023/0325560 A1
(43) Pub. Date: Oct. 12, 2023

(54) A PERIDYNAMICS-BASED FINITE ELEMENT METHOD (PERIFEM) FOR THE ANALYSIS OF STRUCTURAL DAMAGE AND ITS IMPLEMENTATION IN COMMERCIAL SOFTWARE

(71) Applicant: DALIAN UNIVERSITY OF TECHNOLOGY, Dalian (CN)

(72) Inventors: Fei HAN, Dalian (CN); Zhibin LI, Dalian (CN)

(73) Assignee: DALIAN UNIVERSITY OF TECHNOLOGY, Dalian (CN)

(21) Appl. No.: 18/024,780

(22) PCT Filed: Jun. 22, 2022
(86) PCT No.: PCT/CN2022/100311

§ 371 Date: Mar. 6, 2023

(30) Foreign Application Priority Data
Aug. 3, 2021 (CN) 202110885638.8

(51) Int. Cl. G06F 30/23

(52) U.S. Cl. CPC G06F 30/23; G06F 2119/02

(57) ABSTRACT

A peridynamics-based finite element method (PeriFEM) for an structural damage analysis, comprising the following steps: A1: generating finite elements of a structure, A2: generating peridynamic elements based on the finite elements; A3: calculating a global load vector; A4: calculating a global stiffness matrix; A5: formulating and solving a linear algebra equation about the global node displacement vector; A6: evaluating whether the result satisfies the convergence criteria; if so, go to step A7, if not, return to step A4; A7: increasing the external load successively and loop A3-A7 after that, until the external load exceeds the maximum external load; A8: plotting the results. The implementation of PeriFEM in software includes the following operations: B1: generating the peridynamic elements for inputting into the software; B2: programing the formulation of the element stiffness matrix in step A4 as a subroutine; and B3: setting a method for the updating the subroutine.

### CROSS-REFERENCES OF THE RELATED APPLICATIONS

The application is a national stage entry of PCT/CN2022/100311 filed on Jun. 22, 2022, which claims priority to Chinese Pat. application No. 2021108856388 filed on Aug. 03, 2021, the entire contents of which are incorporated herein by reference.

### TECHNICAL FIELD

This invention belongs to the technical field of computational mechanics. It relates to the peridynamics-based finite element method (PeriFEM) for the analysis of structural damage and its implementation in commercial software.

### BACKGROUND

The failure of structures and materials under external loads is a challenging problem in solid mechanics and is essential to engineering applications. It is inevitable to encounter such issues in significant engineering fields such as aerospace, machinery manufacturing, civil and hydraulic engineering, etc. The failure of materials involves discontinuous deformation such as defects, damage, and fracture, so the classical continuum mechanical model based on continuity assumption is no longer applicable. The linear elastic fracture mechanics and continuum damage mechanics that emerged in the 1920s and 1950s are both valuable explorations for the failure of solid mechanics. However, in the traditional linear elastic fracture mechanics, the physical mechanism of crack nucleation is not considered. Therefore, the initial cracks must be introduced artificially, which leads to limitations in predicting crack initiation. In the continuum damage mechanics, it is assumed that the medium is distributed continuously, and a damage variable is defined to describe the damage degree of the medium. Still, this phenomenological treatment doesn’t conform to the objective fact that fracture is a discontinuous deformation.

For the failure of structures and materials, the peridynamic theory, an internationally emerging method, has established a new solid mechanics theory based on nonlocal interaction. In peridynamics, the concept of “bond” between non-contact material points within a finite distance in the body is defined, and the material points interact through the bond. The governing equations of solid mechanics are reconstructed based on the bond in peridynamics: the kinematic admissibility equation describes the deformation of the bond between two material points. This equation has no derivative for space, so the continuity requirement of the deformation is relaxed. The constitutive equation describes the relationship between the bond force and deformation. By defining the fracture criterion of the bond during the simulation process, we can judge whether a bond is broken. The increasing broken bonds can be used to describe the process of spontaneous crack nucleation and propagation. The static admissibility equation is expressed as an integral equation, so it can be used to describe both continuous and discontinuous deformation, which expands the equation’s application scope and solution space. Peridynamics can describe the continuous and discontinuous deformation unified, and can predict the entire process of deformation, damage, fracture, and complete failure of structures and their materials under external loads

Because of the above advantages of peridynamics and the rapidly developing computer technology, it is of great value to use the peridynamic model to efficiently realize structural damage analysis on computers. At present, there are two commonly used numerical methods for the numerical realization of the peridynamic model:

### Meshfree Methods Based on Discrete Particles

In this method, the reference configuration is discretized into several particles with a specific volume. Then the integration operation in the static admissibility equation is approximated by the summation of the interaction force between the particles. Thus, the static admissibility equation can be discretized directly. However, this method has relatively low accuracy and requires many particles for discretization, which can significantly increase the computational cost. In addition, the existing Computer Aided Engineering (CAE) software is mainly developed based on the finite element method in the field of computational solid mechanics. Therefore, the incompatibility between the particle-based mesh-free method and CAE software limits the engineering application of the peridynamic model.

### Finite Element Methods Based on Continuous Elements

In this method, the reference configuration is discretized into a set of finite elements, which do not overlap but share edges and vertices, called nodes, between adjacent elements. According to the piecewise interpolation techniques, the displacement field in each element could be approximately expressed based on the node displacement. Then the original problem could be approximated by the interpolated displacement field In the classical finite element method, the total potential energy of each element is a function of the node displacement of this element, which generates the element stiffness matrix. After that, the global stiffness matrix could be assembled through a specific rule. Finally, the algebraic equilibrium equation about the global node displacement could be obtained. However, due to the nonlocal characteristic of the interaction force between material points in the peridynamics, it is not easy to formulate the total potential energy of each element in the same way as the classical finite element method. Therefore, the numerical implementation process of the peridynamic model based on the element is significantly different from that of the classical finite element method and will be more troublesome. Nowadays, most of the commonly used finite element software platforms in engineering are designed based on the classical finite element method, which makes it difficult to implement the peridynamic model in the existing finite element software platforms, and limits the large-scale engineering application of peridynamics.

### SUMMARY

This invention aims to enrich the existing numerical method of the peridynamic model and take advantage of peridynamics in failure simulation to provide a new numerical method, PeriFEM, which could be used in the commercial finite element software platform to realize structural damage analysis. By constructing a new type of element, called peridynamic element, the PeriFEM, which is suitable for the commercial finite element software platform, is established for structural damage analysis.

To achieve the above purposes, the scheme of the invention is as follows:

The PeriFEM for structural damage analysis includes the following steps:
(A1) Establish the geometric model of the structure Ω, and generate the traditional finite element mesh data according to the user-given mesh size h . Suppose that ₘ finite elements are generated, where the value of ₘ is determined by the geometric size of Ω and the mesh size h;
(A2) Generate the peridynamic elements. For any two finite elements Ωⱼ and Ωᵢ, if the distance dⱼᵢ between Ωⱼ and Ωᵢ satisfies 0 ≤ dⱼᵢ, ≤ δh, Ωⱼ and Ωᵢ are combined into a peridynamic element Ωⱼ (the peridynamic element in this invention is composed of two and only two finite elements, and there is no additional requirement for the dimension, shape, number of nodes and other characteristics of these two finite elements constituting the peridynamic element), where j = 1,2, ···, m, i = 1, 2,···, m, m is the total number of finite elements as mentioned in step (A1), 0 ≤ δ ≤ 100 ;
(A3) Calculate the global load vector F at the current load step based on the finite element, and the formula is:
$$\begin{matrix}\text{F} = {\sum }_{i = 1}^{m} {\text{G}}_{i}^{T} {\text{F}}_{i} ; \\ {\text{F}}_{i} = {\int }_{{Ω}_{i}} {\text{N}}_{i}^{T} \left(x\right) b \left(x\right) \text{d} {V}_{x} ; \\ {\text{N}}_{i} \left(x\right) = \left[\begin{matrix}{N}_{1} \left(x\right) & 0 & 0 & {N}_{2} \left(x\right) & 0 & 0 & ⋯ & {N}_{{n}_{i}} \left(x\right) & 0 & 0 \\ 0 & {N}_{1} \left(x\right) & 0 & 0 & {N}_{2} \left(x\right) & 0 & ⋯ & 0 & {N}_{{n}_{i}} \left(x\right) & 0 \\ 0 & 0 & {N}_{1} \left(x\right) & 0 & 0 & {N}_{2} \left(x\right) & ⋯ & 0 & 0 & {N}_{{n}_{i}} \left(x\right)\end{matrix}\right] ;\end{matrix}$$
where m is the total number of finite elements; G, is the transform matrix of the degree of freedom for the nodes of the finite element Ωⱼ (dᵢ=Gᵢdᵢ,dᵢ is the node displacement vector of the finite element Ωᵢ, and d is the global node displacement vector); ^{.T} represents the transposition of a matrix; F, is the element load vector of the finite element Ωⱼ ; N, (x) is the shape function matrix of the finite element Ωᵢ ; x is the point in the finite element Ωⱼ ; b(x) is the external force vector at the point × ; [·] represents a matrix; nᵢ is the number of nodes of the finite element Ωᵢ ; N_{α} (x) is the shape function of the α th node of the finite element Ωᵢ, α = 1, 2, ..., n, ;
(A4) Calculate the global stiffness matrix K̅ based on the peridynamic element, and the formula is:
$$\begin{matrix}\overline{\text{K}} \text{=} {\sum }_{k = 1}^{\overline{m}} {\overline{\text{G}}}_{k}^{T} {\overline{\text{K}}}_{k} {\overline{\text{G}}}_{k} ; \\ {\overline{\text{K}}}_{k} = {\int }_{{Ω}_{i}} {\int }_{{Ω}_{j}} {\overline{\text{B}}}_{k}^{T} \left({x}^{′} , x\right) \text{D} \left(ξ\right) {\overline{\text{B}}}_{k} \left({x}^{′} , x\right) \text{d} {V}_{{x}^{′}} \text{d} {V}_{x} ; \\ {\overline{\text{B}}}_{k} \left({x}^{′} , x\right) = \left[{\text{N}}_{j} \left({x}^{′}\right) - {\text{N}}_{i} \left(x\right)\right] ; \\ \text{D} \left(ξ\right) = \frac{{c}^{0} \left(ξ\right) μ \left(ξ , t\right)}{{\left‖ξ\right‖}^{2}} \left[\begin{matrix}{ξ}_{1}^{2} & {ξ}_{1} {ξ}_{2} & {ξ}_{1} {ξ}_{3} \\ {ξ}_{2} {ξ}_{1} & {ξ}_{2}^{2} & {ξ}_{2} {ξ}_{3} \\ {ξ}_{3} {ξ}_{1} & {ξ}_{3} {ξ}_{2} & {ξ}_{3}^{2}\end{matrix}\right] ;\end{matrix}$$
where m̅ is the total number of the peridynamic elements; G̅ ₖ is the transform matrix of the degree of freedom for the nodes of the peridynamic element Ω̅ ₖ (d̅ _{k,} .- G̅ ₖd, d̅ ₖ is the node displacement vector of the peridynamic element Ω̅ ₖ, d is the global node displacement vector); .^{T} represents the transposition of a matrix; K̅ ₖ is the element stiffness matrix of the peridynamic element Ωₖ ; B̅ ₖ (x′,x) is the difference matrix for shape function of the peridynamic element Ω̅ ₖ ; x′ is the point in the finite element Ωⱼ ; x is the point in the finite element Ωⱼ ; D(ξ) is the micro-modulus matrix; [·] represents a matrix; N, (x′) is the shape function matrix of the finite element Ωⱼ. ; N, (x) is the shape function matrix of the finite element Ωᵢ ; c⁰(ξ) is the micro-modulus coefficient of bond ξ, and the value of c°(ξ) is related to the material properties of the structure Ω ; µ(ξ,t) is a function with value 0 or 1 related to the bond ξ and the computational step t, where 0 indicates that the bond is broken and 1 indicates that the bond is unbroken; || · || indicates the length of a vector; ξ= x′ - x is the peridynamic bond; ξ₁, ξ₂, ξ₃ is the component of the bond vector ξ;
(A5) Formulate and solve the linear algebra equation about the global node displacement vector d. The equation is:
$$\overline{\text{K}} d = \text{F} \text{;}$$
(A6) Evaluate whether the result satisfies the convergence criteria at the current load step; if so, go to step (A7); if not, return to step (A4);
As the convergence criteria: if ||d^{t} - d^{t-1} ||/||d^{t} ≤ ε, it is recognized that the result is converged, else it is not. ε is the user-defined error tolerance, 10⁻⁸ h ≤ ε ≤ 10⁻¹ h (h is the mesh size), d′ and d^{t-1} are the global node displacement vector obtained from step (A5) at this and last computational step, respectively.

Or, if there is no new broken bond, it is recognized that the result is converged, else it is not;
The way to judge whether a bond is broken is: if the stretch s of the bond ξ in any peridynamic element Ω̅ ₖ is greater than the given critical stretch s_{crit} (in the range (-1,100]), the bond is broken, where s_{crit} is related to the material properties of structure Ω; otherwise, it is unbroken; where s is defined as:
$$\begin{matrix}s = \frac{\left‖ξ + {u}_{j} \left({x}^{′}\right) - {u}_{i} \left(x\right)\right‖ - \left‖ξ\right‖}{\left‖ξ\right‖} ; \\ {u}_{i} \left(x\right) = {\text{N}}_{i} \left(x\right) {d}_{i} ; \\ {u}_{j} \left({x}^{′}\right) = {\text{N}}_{j} \left({x}^{′}\right) {d}_{j} ;\end{matrix}$$
where || · || denotes the length of a vector; ξ = x′ --- x is the peridynamic bond; x′ is the point in the finite element Ωⱼ ; × is the point in the finite element Ωᵢ ; uⱼ, (x′) is the displacement vector at a point x′ in the finite element Ωⱼ ; uᵢ (x) is the displacement vector at a point x in the finite element Ωᵢ ; N, (x) is the shape function matrix of the finite element Ωᵢ ; d, is the node displacement vector of the finite element Ωᵢ ; Nⱼ (x′) is the shape function matrix of the finite element Ωⱼ ; dⱼ is the node displacement vector of the finite element Ωⱼ ;
Or, judge whether there are new broken bonds first; if there is no new broken bond, then do not update the function µ(ξ,t); if there are new broken bonds, then update the function µ(ξ,t) and then update the global stiffness matrix K̅, and the updated global stiffness matrix is labeled as K̅ ^̅{̅n̅e̅w̅}̅ . If |̅|̅ K̅ ^̅{̅n̅e̅w̅}̅ d^{t} - F|| ≤ ε, it is recognized that the result is converged, else it is not. d^{t} is the global node displacement vector obtained from step (A5), F is the global load vector, _{ε} is the user-defined error tolerance;
(A7) Increase the external load successively, and loop steps (A3)-(A7) after that until the external load exceeds the maximum external load;
(A8) Plot the displacement and the effective damage contours of the structure Ω for each computational step based on the global node displacement vector d and the broken bonds information.

As a preferred technical scheme:

In the PeriFEM for the analysis of structural damage as described above, at step (A2), the distance dⱼᵢ between Ωⱼ and Ωⱼ is defined as the distance between the centroid of Ωⱼ and Ωᵢ, δ = 3 ; or the distance dⱼₗ between Ω_{f} and Ωⱼ is defined as the distance between the nearest points of Ωⱼ and Ωᵢ, 0 ≤ δ ≤ 100 ; or the distance (1ⱼᵢ between Ωⱼ and Ωⱼ is defined as the distance between the furthest points of Ωⱼ and Ωⱼ, 0 ≤ δ ≤ 100 .

In the PeriFEM for the analysis of structural damage as described above, at step (A8), the effective damage d_{ξ} (x,t) at any point x in the structure Ω at each computational step t is defined as:

$$\begin{matrix}{d}_{ξ} \left(x , t\right) = \frac{{\int }_{{H}_{δ} \left(x\right)} \left(1 - μ \left(ξ , t\right)\right) {ω}_{c r i t} d {V}_{{x}^{′}}}{{\int }_{{H}_{δ} \left(x\right)} {ω}_{c r i t} d {V}_{{x}^{′}}} ; \\ {H}_{δ} \left(x\right) = \left\{{x}^{′} ∈ {∪}_{j = 1}^{m} {Ω}_{j} : \left‖{x}^{′} - x\right‖ \leq δ h\right\} ; \\ {ω}_{c r i t} = \frac{1}{2} {c}^{0} \left(ξ\right) {s}_{c r i t}^{2} {\left‖ξ\right‖}^{4} ;\end{matrix}$$

where H_{δ} (x) is the peridynamic neighborhood of point x;

$${∪}_{j = 1}^{m} {Ω}_{j}$$

represents the union of all Ωⱼ ; µ(ξ,t) is a function with value 1 or 0 related to the bond ξ and the computational step t; ω _{crit} is the critical energy dissipation of the peridynamic bond; x′ is the point in the finite element Qⱼ ; x is the point in the finite element Ωⱼ ; ||·|| represents the length of a vector; 0 ≤ δ ≤ 100 ; h is the mesh size; c° (ξ) is the micro-modulus coefficient of the bond ξ, and the value of c⁰ (ξ) is related to the material property of the structure Ω ; s_{crit} is the given critical stretch; ξ is the peridynamic bond.

The PeriFEM for analyzing structural damage in this invention is of the consistent computational framework with the classical finite element method and is in good compatibility with the existing commercial finite element software.

This invention also provides a method to implement the PeriFEM for analyzing structural damage described above in the existing commercial finite element software. Based on the Application Programming Interface of the current commercial finite element software (such as ANSYS, ABAQUS, MSC Nastran, MSC Marc, ADINA, etc.), the implementation of the PeriFEM for the analysis of structural damage in the existing commercial finite element software includes the following operations:
(B1) Generate the peridynamic element mesh data based on the finite element mesh data and input them into the commercial finite element software;
(B2) Program the formulation of the element stiffness matrix Kₖ in step (A4) as a subroutine of the software and integrate the subroutine into the commercial software to realize the computation of the element stiffness matrix. In the subroutine, the numerical integration scheme is used to compute the element stiffness matrix K̅ ₖ of the peridynamic element Ω̅ ₖ ; The quadrature points in the finite element Ωⱼ and Ωⱼ of the peridynamic element Ω̅ ₖ are selected individually, and each pair of integration points in Ωⱼ and Ωⱼ forms a peridynamic bond;
(B3) Set a method for the updating of the function µ(ξ,t) that records the broken bonds information as mentioned in step (A6) in the subroutine: after each step (A5), judge whether the peridynamic bond is broken in the subroutine according to the global node displacement vector d, and update the function µ(ξ,t).

As a preferred technical scheme:

As the implementation method described in (B1), suppose that the labels of nodes for the finite element Ωⱼ are

$$\left[\begin{matrix}{\text{P}}_{{j}_{1}} & {\text{P}}_{{j}_{2}} & ⋯ & {\text{P}}_{{j}_{{n}_{j}}}\end{matrix}\right] ,$$

, and suppose that the labels of nodes for the finite element Ωᵢ are

$$\left[\begin{matrix}{\text{P}}_{{i}_{1}} & {\text{P}}_{{i}_{2}} & ⋯ & {\text{P}}_{{i}_{{n}_{i}}}\end{matrix}\right]$$

. Then,if the distance dⱼᵢbetween Ω, and Ωᵢsatisfies 0 ≤ dⱼᵢ ≤ δh

$$0 \leq {d}_{j i} \leq δ h \left(0 \leq δ \leq 100 , h\right)$$

is the mesh size), then Qⱼand Ωⱼ are combined into a peridynamic element Ω̅ ₖ, and the labels of nodes for the peridynamic Ω̅ ₖ is

$$\left[\begin{matrix}{\text{P}}_{{k}_{1}} & {\text{P}}_{{k}_{2}} & ⋯ & {\text{P}}_{{k}_{{\overline{n}}_{k}}}\end{matrix}\right] = \left[\begin{matrix}{\text{P}}_{{j}_{1}} & {\text{P}}_{{j}_{2}} & ⋯ & {\text{P}}_{{j}_{{n}_{j}}} & {\text{P}}_{{i}_{1}} & {\text{P}}_{{i}_{2}} & ⋯ & {\text{P}}_{{i}_{{n}_{i}}}\end{matrix}\right]$$

where n̅ ₖ, = nⱼ + nᵢ is the number of nodes of the peridynamic element Ω̅ ₖ .

The specific steps of the implementation method as described above are as follows:
(C0) Program the formulation of the element stiffness matrix K̅ ₖ of the peridynamic element Ω̅ ₖ,. as a subroutine according to steps (B2) and (B3) and integrate the subroutine into the commercial software;
(C1) Establish the geometric model of the structure Ω in the computer, and generate the traditional finite element mesh data according to the mesh size h after setting the value of h. Then, obtain m finite elements;
(C2) Generate the peridynamic element mesh data according to steps (A2) and (B1)after determining the value of δ and the way for calculating the distance dⱼᵢ. Then, obtain m̅ peridynamic elements;
(C3) Input the load information of the structure Ω into the commercial finite element software;
(C4) Evaluate the deformation and damage of the structure Ω . In commercial software, the subroutine in step (C0) is called for calculating the element stiffness matrix K̅ ₖ of the peridynamic element Ω̅ ₖ,., and the global stiffness matrix K̅ is assembled automatically. For example, program the UserElem subroutine in FORTRAN language in ANSYS; Program the UEL subroutine in FORTRAN language in ABAQUS;
(C5) Obtain the global node displacement vector d in step (A5) automatically according to the load information in step (C3) and the global stiffness matrix K̅ in step (C4) in the commercial finite element software;
(C6) Evaluate whether the result satisfies the convergence criteria at the current load step according to the global node displacement vector d in step (C5) after determining the convergence criteria; if so, go to step (C7); if not, return to step (C4);
(C7) Increase the external load successively, and loop steps (C3)-(C7) after that until the external load exceeds the maximum external load;
(C8) Plot the displacement and the effective damage contours of the structure Ω for each computational step based on the global node displacement vector d and the broken bonds information.

### Beneficial Effect

The PeriFEM for structural damage analysis is compatible with the commercial finite element software. Therefore, it is easy to integrate the peridynamic code into the commercial software on the premise of not changing the framework of the finite element software and the core code; It is convenient to use the peridynamic model to analyze the damage and failure of the structure on the basis of the classical finite element results; At the same time, it is simple to program in-house code or to program based on the finite element software platform based on the Application Programming Interface because of the straightforward numerical computational process of the invention.

### BRIEF DESCRIPTION OF THE DRAWINGS

FIG. 1 is the schematic of the finite element and peridynamic element;

FIG. 2 is the schematic of the generation of the peridynamic element based on finite elements;

FIG. 3 is the schematic of the geometry of the double-edged plate and the prescribed maximum load conditions;

FIG. 4 is the schematic of an unstructured four nodes quadrilateral finite element mesh;

FIG. 5 shows the simulated effective damage of the double-edged plate. FIG. 5A shows the effective damage contours for u_{y} = 2ᵤ ₓ. = 0.35 mm ; FIG. 5B shows the effective damage contours for u_{y} = 2uₓ= 0.5 mm;

FIG. 6 shows the simulated displacement in the X directional of the double-edged plate. FIG. 6A shows the X directional displacement contours for u_{y} = 2uₓ = 0.35 mm ; FIG. 6B shows the X directional displacement contours for u_{y} = 2uₓ = 0.5 mm ;

FIG. 7 shows the simulated displacement in the Y directional of the double-edged plate. FIG. 7A shows the Y directional displacement contours for u_{y} = 2uₓ = 0.35 mm ; FIG. 7B shows the Y directional displacement contours for u_{y} = 2uₓ = 0.5 mm.

### DETAILED DESCRIPTION OF THE EMBODIMENTS

The present invention will be further explained below in conjunction with specific implementations. However, it should be understood that these examples are only used to illustrate this invention and not to limit the scope of this invention. In addition, it should be understood that after reading this invention, those skilled in this technical field can make various changes or modifications to this invention. Therefore, these equivalent forms also fall within the scope defined by the claim of this application.

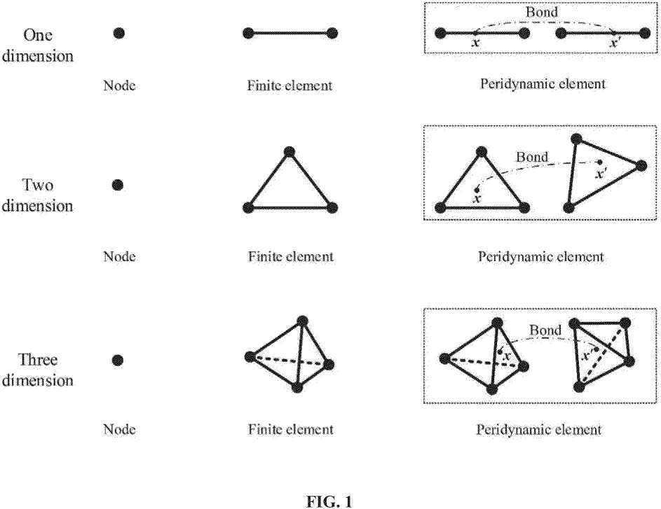

The PeriFEM for structural damage analysis includes the following steps:
(A1) Establish the geometric model of the structure Ω, and generate the traditional finite element mesh data according to the user-given mesh size h . Suppose that m finite elements are generated, where the value of m is determined by the geometric size of Ω and the mesh size h ;
(A2) Generate the peridynamic elements. For any two finite elements Ωⱼ and Ωᵢ (as shown in FIG. 1 ), if the distance dⱼᵢbetween Q_{J} and Ωⱼ satisfies 0 ≤ dⱼᵢ ≤ δh, Ωⱼ and Ωⱼ are combined into a peridynamic element Ω̅ ₖ (as shown in FIG. 1 ), where j = 1, 2, · · ·, m i = 1, 2,···,m, m is the total number of finite elements, 0 ≤ δ ≤ 100 ; the distance dⱼᵢbetween Ωⱼ and Ωᵢ is defined as the distance between the centroid of Ωⱼ and Ωᵢ, δ _{:::} 3 ; or the distance dⱼᵢ between Ωⱼ and Ωᵢ is defined as the distance between the nearest points of Ω, and Ωᵢ, 0 ≤ δ ≤ 100 ; or the distance dⱼᵢ between Ωⱼ and Ωᵢ is defined as the distance between the furthest points of Ωⱼ and Ωᵢ, 0 ≤ δ ≤ 100.
(A3) Calculate the global load vector F at the current load step based on the finite element, and the formula is:
$$\begin{matrix}\text{F} = {\sum }_{i = 1}^{m} {\text{G}}_{i}^{T} {\text{F}}_{i} ; \\ {\text{F}}_{i} = {\int }_{{Ω}_{i}} {\text{N}}_{i}^{T} \left(x\right) b \left(x\right) \text{d} {V}_{x} ; \\ {\text{N}}_{i} \left(x\right) = \left[\begin{matrix}{N}_{1} \left(x\right) & 0 & 0 & {N}_{2} \left(x\right) & 0 & 0 & ⋯ & {N}_{{n}_{i}} \left(x\right) & 0 & 0 \\ 0 & {N}_{1} \left(x\right) & 0 & 0 & {N}_{2} \left(x\right) & 0 & ⋯ & 0 & {N}_{{n}_{i}} \left(x\right) & 0 \\ 0 & 0 & {N}_{1} \left(x\right) & 0 & 0 & {N}_{2} \left(x\right) & ⋯ & 0 & 0 & {N}_{{n}_{i}} \left(x\right)\end{matrix}\right] ;\end{matrix}$$
where m is the total number of finite elements; G, is the transform matrix of the degree of freedom for the nodes of the finite element Ωᵢ ξ dᵢ = G,d, d, is the node displacement vector of the finite element Ωᵢ, and d is the global node displacement vector); ^{.T} represents the transposition of a matrix; F, is the element load vector of the finite element Ωᵢ ; N, (x) is the shape function matrix of the finite element Ωᵢ ; x is the point in the finite element Ωⱼ ; b(x) is the external force vector at the point x ; [.] represents a matrix; n, is the number of nodes of the finite element Ωⱼ ; N_{α} (x) is the shape function of the α th node of the finite element Ωᵢ, α = 1, 2,···,nᵢ ;
(A4) Calculate the global stiffness matrix K̅ based on the peridynamic element, and the formula is:
$$\begin{matrix}\overline{\text{K}} \text{=} {\sum }_{k = 1}^{\overline{m}} {\overline{\text{G}}}_{k}^{T} {\overline{\text{K}}}_{k} {\overline{\text{G}}}_{k} ; \\ {\overline{\text{K}}}_{k} = {\int }_{{Ω}_{i}} {\int }_{{Ω}_{j}} {\overline{\text{B}}}_{k}^{T} \left({x}^{′} , x\right) \text{D} \left(ξ\right) {\overline{\text{B}}}_{k} \left({x}^{′} , x\right) \text{d} {V}_{{x}^{′}} \text{d} {V}_{x} ; \\ {\overline{\text{B}}}_{k} \left({x}^{′} , x\right) = \left[{\text{N}}_{j} \left({x}^{′}\right) - {\text{N}}_{i} \left(x\right)\right] ; \\ \text{D} \left(ξ\right) = \frac{{c}^{0} \left(ξ\right) μ \left(ξ , t\right)}{{\left‖ξ\right‖}^{2}} \left[\begin{matrix}{ξ}_{1}^{2} & {ξ}_{1} {ξ}_{2} & {ξ}_{1} {ξ}_{3} \\ {ξ}_{2} {ξ}_{1} & {ξ}_{2}^{2} & {ξ}_{2} {ξ}_{3} \\ {ξ}_{3} {ξ}_{1} & {ξ}_{3} {ξ}_{2} & {ξ}_{3}^{2}\end{matrix}\right] ;\end{matrix}$$
where m̅ is the total number of the peridynamic elements; G̅ ₖ is the transform matrix of the degree of freedom for the nodes of the peridynamic element Ω̅ ₖ ( d̅ ₖ = G̅ ₖd, d̅ ₖ is the node displacement vector of the peridynamic element Ω̅ ₖ, d is the global node displacement vector); ^{.T} represents the transposition of a matrix; K̅ ₖ̅ is the element stiffness matrix of the peridynamic element fl,, ; B̅ ₖ (x′,x) is the difference matrix for shape function of the peridynamic element Ω̅ ₖ ; x′ is the point in the finite element Ωⱼ ; x is the point in the finite element Ωⱼ ; D(ξ) is the micro-modulus matrix; [·] represents a matrix; Nⱼ (x′) is the shape function matrix of the finite element Ωⱼ ; N, (x) is the shape function matrix of the finite element Ωᵢ ; c⁰(ξ) is the micro-modulus coefficient of bond ξ and the value of c° (ξ) is related to the material properties of the structure Ω; µ(ξ,t) is a function with value 0 or 1 related to the bond ξ and the computational step t, where 0 indicates that the bond is broken and 1 indicates that the bond is unbroken; ||·|| indicates the length of a vector; ξ=x′-x is the peridynamic bond; ξ₁, ξ₂, ξ₃ is the component of the bond vector ξ;
(A5) Formulate and solve the linear algebra equation about the global node displacement vector d. The equation is:
$$\overline{\text{K}} d = \text{F} \text{;}$$
(A6) Evaluate whether the result satisfies the convergence criteria at the current load step; if so, go to step (A7); if not, return to step (A4);
As the convergence criteria: if ||d^{t} ... d^{t-1} ||/||d^{t}|| ≤ ε, it is recognized that the result is converged, else it is not. ε is the user-defined error tolerance, 10⁻⁸ It ≤ ε ≤ 10⁻¹h (h is the mesh size), d^{t} and d^{t-1} are the global node displacement vector obtained from step (A5) at this and last computational step, respectively.

Or, if there is no new broken bond, it is recognized that the result is converged, else it is not;
The way to judge whether a bond is broken is: if the stretch s of the bond ξ in any peridynamic element Ω̅ ₖ is greater than the given critical stretch s_{crit} (in the range (-] 1,100]), the bond is broken, where s_{crit} is related to the material properties of structure Ω; otherwise, it is unbroken; where s is defined as:
$$\begin{matrix}s = \frac{\left‖ξ + {u}_{j} \left({x}^{′}\right) - {u}_{i} \left(x\right)\right‖ - \left‖ξ\right‖}{\left‖ξ\right‖} ; \\ {u}_{i} \left(x\right) = {\text{N}}_{i} \left(x\right) {d}_{i} ; \\ {u}_{j} \left({x}^{′}\right) = {\text{N}}_{j} \left({x}^{′}\right) {d}_{j} ;\end{matrix}$$
where ||_{·}|| denotes the length of a vector; ζ = x′ - x is the peridynamic bond; x′ is the point in the finite element Ωⱼ ; x is the point in the finite element Ωᵢ ; uⱼ (x′) is the displacement vector at a point x′ in the finite element Ωⱼ ; uᵢ (x) is the displacement vector at a point x in the finite element Ωᵢ ; N, (x) is the shape function matrix of the finite element Ωᵢ; d, is the node displacement vector of the finite element Ωᵢ; Nⱼ (x′) is the shape function matrix of the finite element Ωⱼ; dⱼ is the node displacement vector of the finite element Ωⱼ;
Or, judge whether there are new broken bonds first; if there is no new broken bond, then do not update the function µ(ζ,t); if there are new broken bonds, then update the function µ(ζ,t) and then update the global stiffness matrix K̅,̅ and the updated global stiffness matrix is labeled as K̅ ^{new}. If ||K̅ ^{new}d^{t} - F|| ≤ ε, it is recognized that the result is converged, else it is not. d^{t} is the global node displacement vector obtained from step (A5), F is the global load vector, ε is the user-defined error tolerance;
(A7) Increase the external load successively, and loop steps (A3)-(A7) after that until the external load exceeds the maximum external load;
(A8) Plot the displacement and the effective damage contours of the structure Ω for each computational step based on the global node displacement vector d and the broken bonds information, where the effective damage d_{ζ}(x,t) at any point x in the structure Ω at each computational step t is defined as:
$$\begin{matrix}{d}_{ξ} \left(x , t\right) = \frac{{\int }_{{H}_{δ} \left(x\right)} \left(1 - μ \left(ξ , t\right)\right) {ω}_{c r i t} d {V}_{{x}^{′}}}{{\int }_{{H}_{δ} \left(x\right)} {ω}_{c r i t} d {V}_{{x}^{′}}} ; \\ {H}_{δ} \left(x\right) = \left\{{x}^{′} ∈ {∪}_{j = 1}^{m} {Ω}_{j} : \left‖{x}^{′} - x\right‖ \leq δ h\right\} ; \\ {ω}_{c r i t} = \frac{1}{2} {c}^{0} \left(ξ\right) {s}_{c r i t}^{2} {\left‖ξ\right‖}^{4} ;\end{matrix}$$
m where H_{δ} (x) is the peridynamic neighborhood of point
$$x ; {∪}_{j = 1}^{m} {Ω}_{j}$$
represents the union of all Ωⱼ; µ(ζ,t) is a function with value 1 or 0 related to the bond ξ and the computational step t ; ω_{crit} is the critical energy dissipation of the peridynamic bond; x′ is the point in the finite element Ωⱼ ; x is the point in the finite element Ωᵢ; ∥_{·}∥ represents the length of a vector; 0 ≤ ξ ≤ 100 ; h is the mesh size; C⁰ (ξ) is the micro-modulus coefficient of the bond ξ, and the value of c⁰ (ξ) is related to the material property of the structure Ω; S_{crit} is the given critical stretch; ξ is the peridynamic bond. The implementation of the PeriFEM for the analysis of structural damage in the commercial finite element software is based on the Application Programming Interface of the existing commercial finite element software (such as ANSYS, ABAQUS, MSC Nastran, MSC Marc, ADINA, etc.), and the implementation includes the following operations:
(B1) Generate the peridynamic element mesh data based on the finite element mesh data and input them into the commercial finite element software; Specifically, suppose that the labels of nodes for the finite element Ωⱼ are [P_{j₁} P_{j₂} ··· P_{Jₙ ⱼ} ], and suppose that the labels of nodes for the finite element Ωᵢ are [P_{i₁} P_{i₂} ··· P_{iₙ ᵢ} ]. If the distance dⱼᵢ between Ωⱼ and Ωᵢ satisfies 0 ≤ dⱼᵢ ≤ δh (0 ≤ δ ≤ 100, h is the mesh size), then Ωⱼ and Ωᵢ are combined into a peridynamic element Ω̅ ₖ, and the labels of nodes for the peridynamic element Ω̅ ₖ is [P_{k₁} P_{k₂} ··· Pₖ ₙ̅ ₖ ]=[P_{j₁} P_{j₂} ··· P_{jₙ ⱼ} P_{i₁} P_{i₂} ··· Pᵢₙᵢ ], where n̅ₖ = nⱼ +nᵢ is the number of nodes of the peridynamic element Ω̅ ₖ.
(B2) Program the formulation of the element stiffness matrix K̅ ₖ in step (A4) as a subroutine of the software and integrate the subroutine into the commercial software to realize the computation of the element stiffness matrix. In the subroutine, the numerical integration scheme is used to compute the element stiffness matrix K̅ ₖ of the peridynamic element Ω̅ ₖ; The quadrature points in the finite element Ωⱼ and Ωᵢ of the peridynamic element Ω̅ ₖ are selected individually, and each pair of integration points in Ωⱼ and Ωᵢ forms a peridynamic bond;
(B3) Set a method for the updating of the function µ(ζ,t) that records the broken bonds information as mentioned in step (A6) in the subroutine: after each step (A5), judge whether the peridynamic bond is broken in the subroutine according to the global node displacement vector d, and update the function µ(ξ,t).

The specific steps of implementation of the PeriFEM for the analysis of structural damage in the commercial finite element software are as follows:
(C0) Program the formulation of the element stiffness matrix K̅ ₖ of the peridynamic element Ω̅ ₖ as a subroutine according to steps (B2) and (B3) and integrate the subroutine into the commercial software;
(C1) Establish the geometric model of the structure Ω in the computer, and generate the traditional finite element mesh data according to the mesh size h after setting the value of h. Then, obtain m finite elements;
(C2) Generate the peridynamic element mesh data according to steps (A2) and (B1) after determining the value of δ and the way for calculating the distance dⱼ₁. Then, obtain m̅ peridynamic elements;
(C3) Input the load information of the structure Ω into the commercial finite element software;
(C4) Evaluate the deformation and damage of the structure Ω. In commercial software, the subroutine in step (C0) is called for calculating the element stiffness matrix K̅ ₖ of the peridynamic element Ω̅ ₖ, and the global stiffness matrix K̅ is assembled automatically;
(C5) Obtain the global node displacement vector d in step (A5) automatically according to the load information in step (C3) and the global stiffness matrix K̅ in step (C4) in the commercial finite element software;
(C6) Evaluate whether the result satisfies the convergence criteria at the current load step according to the global node displacement vector d in step (C5) after determining the convergence criteria; if so, go to step (C7); if not, return to step (C4);
(C7) Increase the external load successively, and loop steps (C3)-(C7) after that until the external load exceeds the maximum external load;
(C8) Plot the displacement and the effective damage contours of the structure Ω for each computational step based on the global node displacement vector d and the broken bonds information.

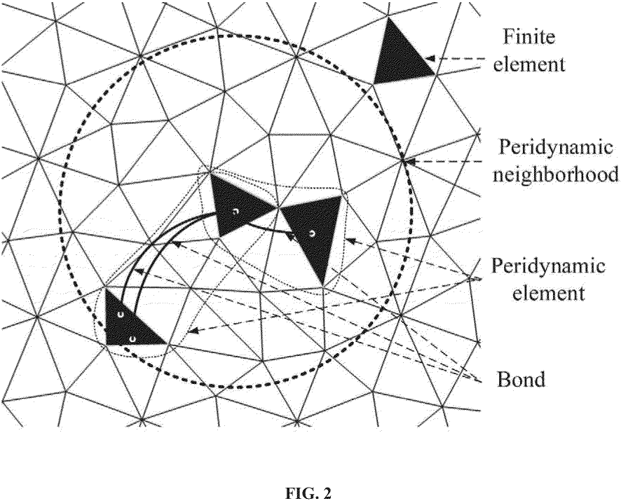

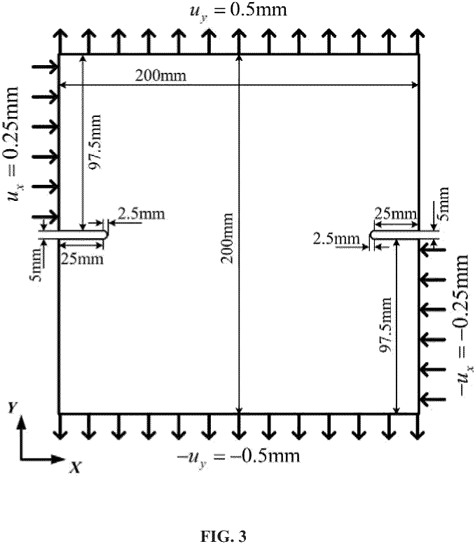

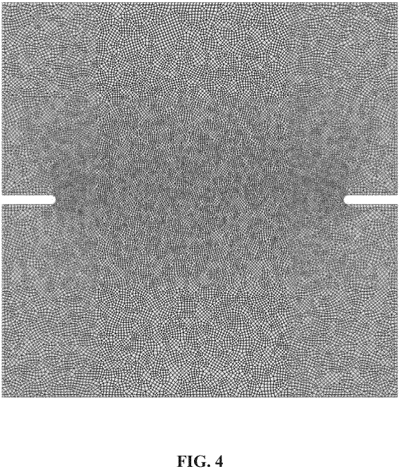

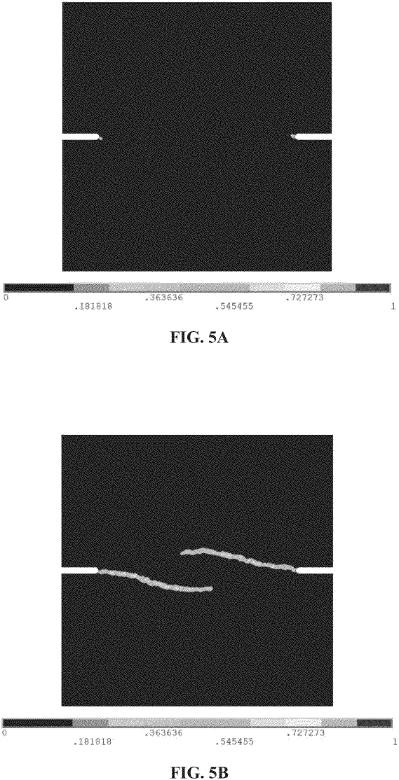

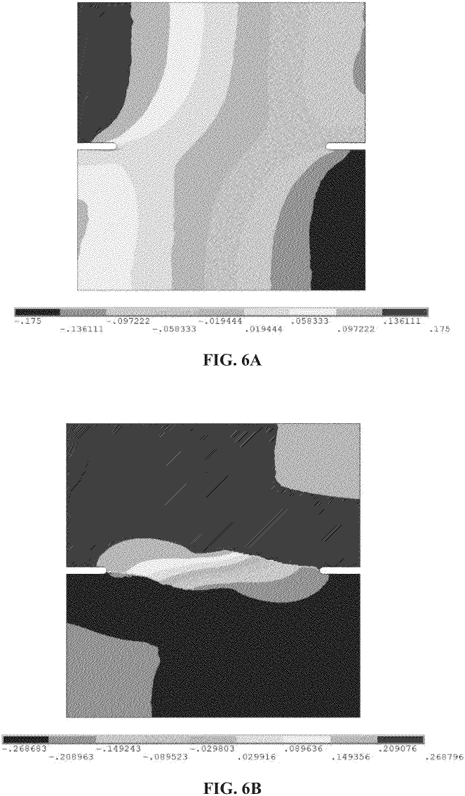

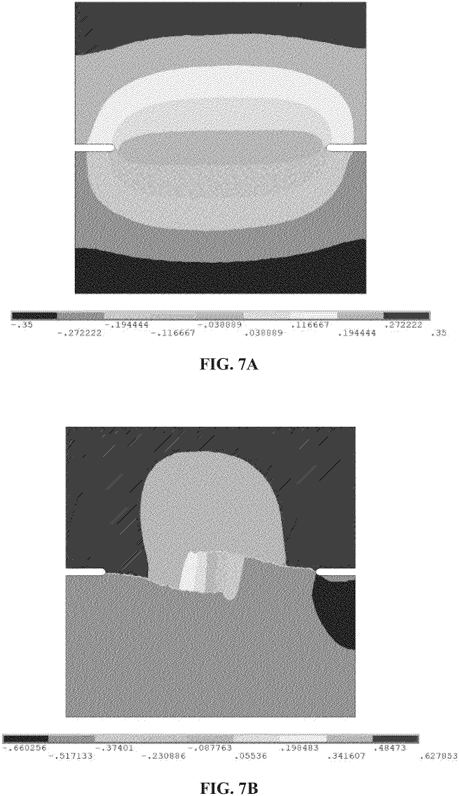

The implementation details of PeriFEM in commercial software will be further demonstrated through the following sample:
Problem setting: consider a 2-dimensional problem, a double-edged plate. Its geometry and maximum load conditions are shown in FIG. 3 . The maximum load condition is: horizontal displacement is uₓ = 0.25 mm, vertical displacement is u_{y} = 0.5 mm; in this sample, the effect of external force load is not considered, and Young’s modulus and Poisson’s ratio of the structure are defined as E = 30 GPa and v = ⅓, respectively; in 2-dimension, the schematic of the generation of the peridynamic element based on the finite elements is shown in FIG. 2 ; the 4-node quadrilateral finite element mesh, as shown in FIG. 4 , is used in this sample;
The implementation of the PeriFEM for the analysis of structural damage in the commercial finite element software (ANSYS) includes the following steps:
   (C0) Program the formulation of the element stiffness matrix K̅ ₜ of an 8-node peridynamic element Ω̅ ₖ as a subroutine and integrate it into the commercial software; the updating method of the function µ(ξ,t) in the subroutine is: after step (A5), judge whether the peridynamic bond is broken in the subroutine according to the global node displacement vector d, and update the function µ(ξ,t).
   (C1) Establish the geometric model of the structure in the computer, and generate the traditional finite element mesh according to the mesh size h = 1.2. Then, obtain m = 27741 finite elements.
   (C2) Generate the peridynamic element mesh data according to steps (A2) and (B1) after defining dⱼᵢ the centroid distance between Ωⱼ and Ωᵢ, δ = 3; Then, m̅ = 1085727 peridynamic elements are obtained;
   (C3) Input the initial and maximum load information of the structure into the commercial finite element software; where the initial load information is: the horizontal displacement uₓ = 0.025 mm, the vertical displacement u_{y} = 0.05 mm;
   (C4) Evaluate the deformation and damage of the structure Ω. In commercial software, the subroutine in step (C0) is called for calculating the element stiffness matrix K̅ ₖ of the peridynamic element Ωₖ, and the global stiffness matrix K̅ is assembled automatically;
   (C5) Obtain the global node displacement vector d as mentioned in step (A5) automatically according to the load information in step (C3) and the global stiffness matrix K̅ in step (C4) in the commercial finite element software;
   (C6) Evaluate whether the result satisfies the convergence criteria at the current load step according to the global node displacement vector d in step (C5) after determining the convergence criteria; if so, go to step (C7); if not, return to step (C4); in this example, no new broken bond is set as the convergence criterion;
   (C7) Increase the external load successively (the horizontal displacement uₓ = 0.025 mm, the vertical displacement u_{y} = 0.05 mm), and loop steps (C3)-(C7) after that until the external load exceeds the maximum external load;
   (C8) Plot the displacement and the effective damage contours of the structure for each computational step based on the global node displacement vector d and the broken bonds information; The effective damage contour for u_{y} = 2uₓ = 0.35 mm is shown in FIG. 5A, the X directional displacement contour for u_{y} = 2uₓ = 0.35 mm is shown in FIG. 6A, the Y directional displacement contour for u_{y} = 2uₓ = 0.35 mm is shown in FIG. 7A; the effective damage contour for u_{y} = 2uₓ = 0.5 mm is shown in FIG. 5B, the X directional displacement contour for u_{y} = 2uₓ = 0.5 mm is shown in FIG. 6B, the Y directional displacement contour for u_{y} = 2uₓ = 0.5 mm is shown in FIG. 7B.

1. A PeriFEM for a structural damage analysis, comprising following steps:
A1: establishing the geometric model of a structure Ω, and generating m traditional finite elements according to a mesh size h ;
A2: generating peridynamic elements;: for any two finite elements Ωⱼ and Ωᵢ, if the distance dⱼᵢ, between Ωⱼ and Ωᵢ satisfies 0 ≤ dⱼₜ ≤ δh, Ωⱼ and Ωᵢ are combined into a peridynamic element Ω̅ ₖ, where J = 1, 2, ⋯, m, i =1,2,⋯,m, 0 ≤ δ ≤ 100 ;
A3: calculating the global load vector F based on the finite elements, and the formula is:
$$\text{F=} {\sum }_{i = 1}^{m} {\text{G}}_{i}^{T} {\text{F}}_{i} ;$$
$${\text{F}}_{i} = {\int }_{{\text{Ω}}_{i}} {\text{N}}_{i}^{T} \left(x\right) b \left(x\right) \text{d} {V}_{x} ;$$
$$\begin{matrix}{\text{N}}_{i} \left(x\right) = \\ \left[\begin{matrix}{N}_{1} \left(x\right) & 0 & 0 & {N}_{2} \left(x\right) & 0 & 0 & ⋯ & {N}_{{n}_{i}} \left(x\right) & 0 & 0 \\ 0 & {N}_{1} \left(x\right) & 0 & 0 & {N}_{2} \left(x\right) & 0 & ⋯ & 0 & {N}_{{n}_{i}} \left(x\right) & 0 \\ 0 & 0 & {N}_{1} \left(x\right) & 0 & 0 & {N}_{2} \left(x\right) & ⋯ & 0 & 0 & {N}_{{n}_{i}} \left(x\right)\end{matrix}\right] ;\end{matrix}$$
where Gᵢ is the transform matrix of the degree of freedom for the nodes of the finite element Ωᵢ ; Fᵢ is the element load vector of the finite element Ωᵢ; Nᵢ (x) is the shape function matrix of the finite element Ωᵢ ; x is the point in the finite element Ωᵢ; b(x) is the external force vector at the point x ; nᵢ is the number of nodes of the finite element Ωᵢ ; N_{α} (x) is the shape function of the αth node of the finite element Ωᵢ, α =1, 2,⋯,nᵢ ;
A4: calculating the global stiffness matrix K based on the peridynamic element, and the formula is:
$$\overline{\text{K}} = {\sum }_{k = 1}^{\overline{m}} {\overline{\text{G}}}_{k}^{T} {\overline{\text{K}}}_{k} {\overline{\text{G}}}_{k} ;$$
$${\overline{\text{K}}}_{k} = {\int }_{{\text{Ω}}_{i}} {\int }_{{\text{Ω}}_{j}} {\overline{\text{B}}}_{k}^{T} \left({x}^{′} , x\right) \text{D} \left(ξ\right) {\overline{\text{B}}}_{k} \left({x}^{′} , x\right) \text{d} {V}_{{x}^{′}} \text{d} {V}_{x} ;$$
$${\overline{\text{B}}}_{k} \left({x}^{′} , x\right) = \left[\begin{matrix}{\text{N}}_{j} \left({x}^{′}\right) & - {\text{N}}_{i} \left(x\right)\end{matrix}\right] ;$$
$$\text{D} \left(ξ\right) = \frac{{c}^{0} \left(ξ\right) μ \left(ξ , t\right)}{{\left‖ξ\right‖}^{2}} \left[\begin{matrix}{ξ}_{1}^{2} & {ξ}_{1} {ξ}_{2} & {ξ}_{1} {ξ}_{3} \\ {ξ}_{2} {ξ}_{1} & {ξ}_{2}^{2} & {ξ}_{2} {ξ}_{3} \\ {ξ}_{3} {ξ}_{1} & {ξ}_{3} {ξ}_{2} & {ξ}_{3}^{2}\end{matrix}\right] ;$$
where m is the total number of the peridynamic elements;
G̅ ₖ is a transform matrix of the degree of freedom for the nodes of the peridynamic element Ω̅ ₖ; K̅ ₖ is an element stiffness matrix of the peridynamic element Ω̅ ₖ ; B̅ ₖ (x′, x) is a difference matrix for shape function of the peridynamic element Ω̅ ₖ ; x′ is a point in the finite element Ωⱼ ; D(ξ) is a micro-modulus matrix; Nⱼ (x′) is a shape function matrix of the finite element Ωⱼ ; c⁰ (ξ) is a micro-modulus coefficient of bond ξ; µ(ξ,t) is a function valued 0 or 1 related to the bond ξ and the computational step t, where 0 indicates that the bond is broken and 1 indicates that the bond is unbroken; ||·|| indicates the length of a vector; ξ = x′ - x is the peridynamic bond; (ξ₁, ξ₂, ξ₃ is the component of the bond vector ξ;
A5: formulating and solving a linear algebra equation about the global node displacement vector d; the equation is:
$$\overline{\text{K}} d = \text{F} ;$$
A6: evaluating whether the result satisfies the convergence criteria at the current load step; if so, go to step A7; if not, return to step (A4);
according to a convergence criteria: if ∥d^{t} - d^{t-1}∥/∥d^{t}∥≤ ε, 10⁻⁸ h ≤ ε ≤ 10⁻¹h, it is recognized that the result is converged, else it is not; ε is a user-defined error tolerance, 10⁻⁸ h ≤ ε ≤ 10⁻¹h ( h is the mesh size), d^{t} and d^{t-1} are the global node displacement vector obtained from step A5 at this and the last computational step, respectively;
or, if there is no new broken bond, it is recognized that the result is converged, else it is not;
the way to judge whether a bond is broken is: if the stretch s _of the bond ξ in any peridynamic element Ω̅ ₖ is greater than the given critical stretch s_{crit}, the bond is broken, where s_{crit} is related to the material properties of structure Ω ; otherwise, it is unbroken; where s is defined as:
$$s = \frac{\left‖ξ + {u}_{j} \left({x}^{′}\right) - {u}_{i} \left(x\right)\right‖ - \left‖ξ\right‖}{\left‖ξ\right‖} ;$$
$${u}_{i} \left(x\right) = {\text{N}}_{i} \left(x\right) {d}_{i} ;$$
$${u}_{j} \left({x}^{′}\right) = {\text{N}}_{j} \left({x}^{′}\right) {d}_{j} ;$$
where u
ⱼ, (x′) is a displacement vector at a point x′ in the finite element Ωⱼ ; uᵢ (x) is a displacement vector at a point ₓ in the finite element Ωᵢ ; dᵢ is a node displacement vector of the finite element Ωᵢ ; dⱼ is a node displacement vector of the finite element Ωⱼ ;
or, judge whether there are new broken bonds first; if there is no new broken bond, then do not update the function µ(ξ,t); if there are new broken bonds, then update the function µ(ξ,t) and then update the global stiffness matrix K, and the updated global stiffness matrix is labeled as K̅ ^{new} ; if ∥K̅ ^{new}d^{t} - F∥ ≤ ε, it is recognized that the result is converged, else it is not;
A7: increasing the external load successively, and loop steps A3 A7 after that until the external load exceeds the maximum external load; and
A8: plotting the displacement and the effective damage contours of the structure Ω for each computational step based on the global node displacement vector d and the broken bonds information.

2. The PeriFEM for the structural damage analysis according to claim 1, wherein at step A2, the distance dⱼₜ between Ωⱼ and Ωᵢ is defined as the distance between the centroid of Ωⱼ and Ωᵢ, δ = 3 ; or the distance dⱼᵢ, between Ωⱼ and Ωᵢ is defined as the distance between the nearest points of Ωⱼ and Ωᵢ, 0 ≤ δ ≤ 100 ; or the distance dⱼᵢ, between Ωⱼ and Ωᵢ is defined as the distance between the furthest points of Ωⱼ and Ωᵢ, 0 ≤ δ ≤ 100 .

3. The PeriFEM for the structural damage analysis according to claim 1, wherein at step A8, the effective damage d_{ξ}(x,t) at each point x in the structure Ω at each computational step t is defined as:
$${d}_{ξ} \left(x , t\right) = \frac{{\int }_{{H}_{δ} \left(x\right)} \left(1 - μ \left(ξ , t\right)\right) {ω}_{c r i t} d {V}_{{x}^{′}}}{{\int }_{{H}_{δ} \left(x\right)} {ω}_{c r i t} d {V}_{{x}^{′}}} ;$$
$${H}_{δ} \left(x\right) = \left\{{x}^{′} ∈ {∪}_{j = 1}^{m} {\text{Ω}}_{j} : \left‖{x}^{′} - x\right‖ \leq δ h\right\} ;$$
$${ω}_{c r i t} = \frac{1}{2} {c}^{0} \left(ξ\right) {s}_{c r i t}^{2} {\left‖ξ\right‖}^{4} ;$$
where H_{δ} (x) is the peridynamic neighborhood of point ₓ ;
$${∪}_{j = 1}^{m} {\text{Ω}}_{j}$$
represents the union of all Ω
ⱼ; ω_{crit} is the critical energy dissipation of the peridynamic bond.

4. An implementation method of the PeriFEM for the structural damage analysis according to claim 1 in commercial software, comprising using an Application Programming Interface of the existing commercial finite element software, implementing the PeriFEM for the structural damage analysis in the current commercial finite element software, and including the following operations:
B1: generating the peridynamic element mesh data based on the finite element mesh data and input them into the commercial finite element software;
B2: programing the formulation of the element stiffness matrix K̅ ₖ in step A4 as a subroutine of the software and integrate the subroutine into the commercial software. In the subroutine, the numerical integration scheme is used to compute the element stiffness matrix K̅ ₖ of the peridynamic element Ω̅ ₖ; the quadrature points in the finite element Ωⱼ, and Ωᵢ of the peridynamic element Ω̅ ₖ are selected individually, and each pair of integration points in Ωⱼ and Ωᵢ forms a peridynamic bond;
B3: setting a method for the updating of the function µ(ξ,t) that records the broken bonds information as mentioned in step A6 in the subroutine: after each step A5, judginge whether the peridynamic bond is broken in the subroutine according to the global node displacement vector d, and updating the function µ(ξ,t).

5. The implementation method according to claim 4, wherein in step B1, suppose that the labels of nodes for the finite element Ωⱼ are [Pⱼ₁ Pⱼ₂ ··· Pⱼₙⱼ ], and suppose that the labels of nodes for the finite element Ωᵢ are [Pᵢ₁ Pₗ₂ ··· Pₜₙₜ ] ; then, if the distance dⱼᵢ between Ωⱼ and Ωᵢ satisfies 0 ≤dⱼᵢ ≤ δh, then Ωⱼ and Ωᵢ are combined into a peridynamic element Ω̅ ₖ, and the labels of nodes for the peridynamic element Ω̅ ₖ are [Pₖ₁ Pₖ₂ ··· Pₖₙₖ ] = [Pⱼ₁ Pⱼ₂ ··· Pⱼₙⱼ Pᵢ₁ Pᵢ₂ ··· Pᵢₙᵢ ], where n̅ₖ = nⱼ + nᵢ is the number of nodes of the peridynamic element Ωₖ.

6. The implementation method according to claim 4, further comprising the following steps:
C0: programing the formulation of the element stiffness matrix K̅ ₖ of the peridynamic element Ω̅ ₖ as a subroutine according to steps B2 and B3 and integrating the subroutine into the commercial software;
C1: establishing the geometric model of the structure Ω in the computer, and generate the traditional finite element mesh data according to the mesh size h after setting the value of h; then, obtaining m finite elements;
C2: generating the peridynamic element mesh data according to steps A2 and (B1) after determining the value of δ and the way for calculating the distance d_{ji,}; then, obtain m̅ peridynamic elements;
C3: inputting the load information of the structure Ω into the commercial finite element software;
C4: evaluating the deformation and damage of the structure Ω ; in commercial software, the subroutine in step C0 is called for calculating the element stiffness matrix K̅ ₖ of the peridynamic element Ω̅ ₖ, and the global stiffness matrix K̅ is assembled automatically;
C5: obtaining the global node displacement vector d as mentioned in step A5 automatically according to the load information in step C3 and the global stiffness matrix K̅ in step C4 in the commercial finite element software;
C6: evaluating whether the result satisfies the convergence criteria at the current load step according to the global node displacement vector d in step C5 after determining the convergence criteria; if so, go to step (C7); if not, return to step (C4);
C7: increasing the external load successively, and loop steps C3-C7 after that until the external load exceeds the maximum external load;
C8: plotting the displacement and the effective damage contours of the structure Ω for each computational step based on the global node displacement vector d and the broken bonds information.

7. The implementation method according to claim 4, wherein at step A2, the distance dⱼᵢ between Ωⱼ and Ωᵢ is defined as the distance between the centroid of Ωⱼ and Ωᵢ, δ = 3; or the distance dⱼᵢ between Ωⱼ and Ωᵢ is defined as the distance between the nearest points of Ωⱼ and Ωₗ, 0 ≤ δ ≤ 100 ; or the distance dⱼᵢ between Ωⱼ and Ωᵢ is defined as the distance between the furthest points of Ωⱼ and Ωᵢ 0 ≤ δ ≤ 100.

8. The implementation method according to claim 4, wherein at step A8, the effective damage d_{ξ}(x,t) at each point x in the structure Ω at each computational step t is defined as:
$${d}_{ξ} \left(x , t\right) = \frac{{\int }_{{H}_{δ} \left(x\right)} \left(1 - μ \left(ξ , t\right)\right) {ω}_{c r i t} d {V}_{{x}^{′}}}{{\int }_{{H}_{δ} \left(x\right)} {ω}_{c r i t} d {V}_{{x}^{′}}} ;$$
$${H}_{δ} \left(x\right) = \left\{{x}^{′} ∈ {∪}_{j = 1}^{m} {\text{Ω}}_{j} : \left‖{x}^{′} - x\right‖ \leq δ h\right\} ;$$
$${ω}_{c r i t} = \frac{1}{2} {c}^{0} \left(ξ\right) {s}_{c r i t}^{2} {\left‖ξ\right‖}^{4} ;$$
where H_{δ} (x) is the peridynamic neighborhood of point x;
$${∪}_{j = 1}^{m} {\text{Ω}}_{j}$$
represents the union of all Ω
ⱼ; ω_{crit} is the critical energy dissipation of the peridynamic bond.

9. The implementation method according to claim 6, wherein in step B1, suppose that the labels of nodes for the finite element Ωⱼ are [Pⱼ₁ Pⱼ₂ ··· Pⱼₙⱼ ], and suppose that the labels of nodes for the finite element Ωᵢ are [Pᵢ₁ Pᵢ₂ ··· Pᵢₙᵢ ] ; then, if the distance dⱼᵢ between Ωⱼ and Ωᵢ satisfies 0 ≤ dⱼᵢ ≤ δh, then Ωⱼ and Ωᵢ are combined into a peridynamic element Ωₖ, and the labels of nodes for the peridynamic element Ω̅ ₖ are [Pₖ₁ Pₖ₂ ··· Pₖₙₖ ] = [Pⱼ₁ Pⱼ₂ ··· Pⱼₙⱼ Pᵢ₁ Pᵢ₂ ··· Pᵢₙᵢ ], where n̅ₖ = nⱼ + nᵢ is the number of nodes of the peridynamic element Ω̅ ₖ.
